(19) United States
(12) Patent Application Publication
(10) Pub. No.: US 2004/0064523 A1
(43) Pub. Date: Apr. 1, 2004

(54) Placing an object at a node within a logical space in a peer-to-peer system

(76) Inventors: Zheng Zhang, San Jose, CA (US); Mallik Mahalingam, Sunnyvale, CA (US); Zhichen Xu, Sunnyvale, CA (US); Wenting Tang, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/260,425

(22) Filed: Oct. 1, 2002

(51) Int. Cl. G06F 15/16

(52) U.S. Cl. 709/217

(57) ABSTRACT

A peer-to-peer system includes a plurality of nodes functioning as a distributed, shared, file system. A node of the plurality of nodes is operable to randomly place an object within a logical space relative to a parent node hosting a parent object in the peer-to-peer system.

### FIELD OF THE INVENTION

The invention is generally related to peer-to-peer systems. More particularly, the invention is related to placing an object in a peer-to-peer system.

### BACKGROUND OF THE INVENTION

With the rapid growth of the Internet and the ever-rising demand of applications, building a highly scalable infrastructure is increasingly important. A peer-to-peer (P2P) system provides an infrastructure that may meet those demands, especially for storage systems.

A P2P system of nodes (or peers) interconnected via one or more networks provides a relatively convenient and scalable means for storing and exchanging information. However, current P2P storage systems offer a flat storage space, where no techniques other than using distributing hash tables to store and retrieve objects are employed for structuring data stored in the P2P systems. In reality, applications and users typically organize data in a structured form, such as employed in conventional file systems using a hierarchical namespace (e.g., a tree-like structure starting from a root directory and branching to sub-directories).

One approach to building a hierarchical namespace for a file system on a P2P system may include hashing an entire pathname of an object into a random key. Using this technique, object placement and retrieval is performed by deriving a key using a hash function. A key identifies a full path (e.g., /a/b/d) to an object, such that a client may retrieve an object directly using the key. Each path to an object is hashed to a specific key. For example, for a P2P system employing a content addressable network (CAN) architecture, path “/a/b” is hashed to a point P_{/a/b} and path “/a/b/c” is hashed to a point P_{a/b/c} in the Cartesian coordinate system for the CAN system.

If the full pathname is used to store and retrieve object, such as described above (e.g., by hashing the whole path name to derive the key), removing or renaming a component in the path may result in mass relocation of objects. Because each object is hashed to a specific key, the new pathname may not yield the same hash value, requiring objects to be relocated.

For example, a path “/a/b” has a component “b”. If “b” is renamed to “b′”, the directory “/a/b′” is hashed to a different point and thus has to be relocated physically. Furthermore, all the pathnames following the directory “b” (now b′) are affected. For example, if directories “/a/b/d” and “/a/b/e” exist, they are also hashed to different points and physically relocated. On a large scale, this relocation may cause severe instability in the system.

### SUMMARY OF THE INVENTION

According to an embodiment of the invention, a method for placing an object in a peer-to-peer system comprises identifying a location of parent object; identifying a logical space relative to the location of the parent object; selecting a node within the logical space; and placing the object at the selected node.

According to another embodiment of the invention, a peer-to-peer system comprises a plurality of nodes functioning as a distributed, shared, file system, where a node of the plurality of nodes is operable to randomly place an object within a logical space relative to a parent node hosting a parent object.

According to yet another embodiment of the invention, an apparatus connected to a peer-to-peer system comprises means for identifying a location of parent object; means for identifying a logical space relative to the location of the parent object; means for selecting a node within the logical space; and means for placing the object at the selected node.

### BRIEF DESCRIPTION OF THE DRAWINGS

The present invention is illustrated by way of example and not limitation in the accompanying figures in which like numeral references refer to like elements, and wherein:

FIG. 1 illustrates a P2P system, according to an embodiment of the invention;

FIG. 2 illustrates a lookup performed in the P2P system shown in FIG. 1, according to an embodiment of the invention;

FIG. 3 illustrates placing an object in the P2P system shown in FIG. 1, according to an embodiment of the invention;

FIG. 4 illustrates a flow diagram of a method for placing an object in a P2P system, according to an embodiment of the invention; and

FIG. 5 illustrates a computer platform for a node in a P2P system, according to an embodiment of the invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

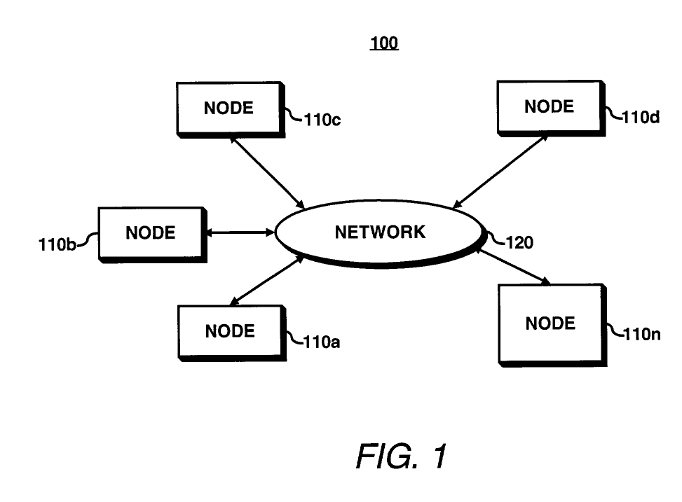

FIG. 1 illustrates an exemplary block diagram of a system 100 where an embodiment of the present invention may be practiced. It should be readily apparent to those of ordinary skill in the art that the system 100 depicted in FIG. 1 represents a generalized schematic illustration and that other components may be added or existing components may be removed or modified without departing from the spirit or scope of the present invention.

As shown in FIG. 1, the system 100 includes a plurality of nodes 110a . . . 110n functioning as peers in a P2P system. The nodes 110a . . . 110n may be operable to exchange information among themselves and with other network nodes over a network 120. The nodes 110a . . . 110n may also be operable to determine which nodes 110a . . . 110n are valid and perform other functions (object search and retrieval, object placement, etc.) of a peer in a P2P system. Objects may include files, URLs, etc. The nodes 110a . . . 110n may be computing platforms (e.g., personal digital assistants, laptop computers, workstations, servers, and other similar devices) that have a network interface. The nodes 110a . . . 110n may be further operable to execute one or more software applications (not shown) that include the capability to share information (e.g., data, applications, etc.) in a P2P manner.

The network 120 may be operable to provide a communication channel among the nodes 110a . . . 110n. The network 120 may be implemented as a local area network, wide area network or combination thereof. The network 120 may implement wired protocols, such as Ethernet, token ring, etc., wireless protocols, such as Cellular Digital Packet Data, Mobitex, IEEE 801.11b, Bluetooth, Wireless Application Protocol, Global System for Mobiles, etc., or combination thereof.

In one embodiment, the system 100 is a distributed hash system (e.g., CAN, Pastry, Tapestry, Chord, etc.). In a distributed hash system a lookup for locating an object in the system 100 is performed by searching with a key associated with the object. These systems typically “guarantee” the retrieval of an existing object by searching with the key, as apposed to a system, such as Freenet, which typically does not provide an equivalent level of “guaranteed” object retrieval. In one embodiment, the system 100 includes a distributed file system having a conventional tree-like structure is overlaid on a P2P system. Each object (e.g., directories containing meta data, files containing other data, etc.) in the system 100, which can reside on any of the nodes 110a . . . n, contains names of children objects and location information (e.g., point(s) in the Cartesian space in the case of CAN) for each child object. Name and location information for children objects may be stored as meta data with the objects. When location information is provided with directories, the placement of objects in the system 100 becomes controllable. Objects may be placed in the system 100 to minimize lookup costs, such as described in detail below.

Lookups comprise a high portion of total metadata operations in file systems. A lookup in a file system is performed to resolve a location of an object. This is done by resolving one component at a time in a path to the object until all the components in the path are resolved. At the end of the lookup process the location of where the object resides is returned.

In the system 100, where a distributed file system is overlaid on a P2P system, a parent object may reside at one location in the P2P system, and a child object may reside in another location in the P2P system. The locations, for example, can be same node in the P2P system, different file systems within the same node, or different nodes altogether. This is generally irrespective of whether or not the distributed file system is overlaid on a P2P system.

In order to resolve a path to an object in the system 100, a lookup operation may require visiting every component in the path. Path resolution typically includes routing a query to a node hosting the parent object. The parent object, which may be a parent directory, then transmits the query to the next component in the path to the object. Because each object in the system 100 may include location information for children objects in the system 100, each object can route the query to a child object in the path. The query is transmitted to each component in the path until the desired object is located. After the path is resolved, the object may be retrieved using the path.

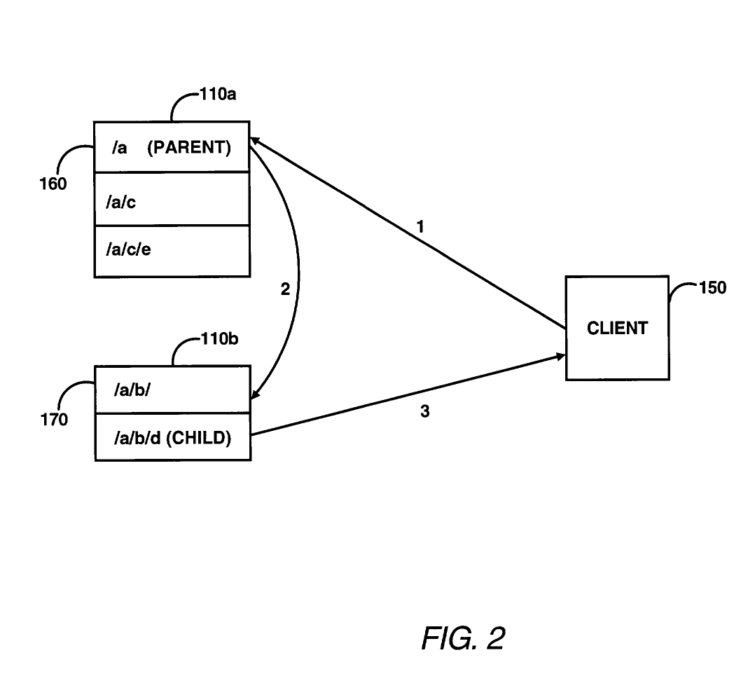

FIG. 2 illustrates a lookup performed in the system 100, according to an embodiment of the invention. A parent object 160 is the directory “/a”, hosted by the node 110a. The node 110a also includes subdirectories “/a/c” and “/a/c/e”. The node 110b includes subdirectories “/a/b” and “/a/b/d”. The child object 170 (e.g., a file) is stored in the subdirectory “/a/b/d”.

The client 150 transmits a query to the parent node (i.e., node 110a) containing the parent object, shown as 1. The parent node transmits the query to the next component in the path to the child object 170, which is “/a/b” at the node 110b (shown as 2). The node 110b also contains the child object 170 stored in the subdirectory “/a/b/d”. The location of the child object 170 is returned to the client 150 (shown as 3) and the path to the child object 170 is resolved.

Lookup costs may be measured based on the number of routing hops (i.e., logical hops) taken by the query in the system 100. A lookup cost may be expressed as D multiplied by h, where D is the length of a complete path (e.g., “/a/b/d”) to an object and h is the number of logical routing hops resolving one component of the path. The logical hop is a routing hop in an overlay network, such as CAN. Each logical hop may comprise multiple IP-level physical hops.

By controlling placement, lookup costs for the system 100 may be minimized. For example, by placing child objects in close proximity to parent objects, the number of logical hops taken by a query for resolving a path are limited.

According to an embodiment of the invention, objects may be placed in the system 100 using a radius delta algorithm, which minimizes lookup costs. The radius-delta algorithm places a child object within a predetermined distance, in terms of logical hops, to a parent object. Thus, lookup costs are minimized by limiting the number of logical hops a child object is placed from a parent object.

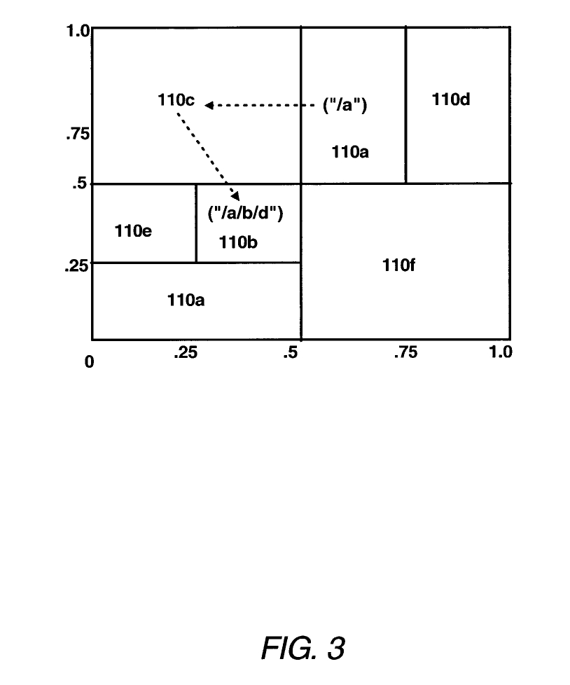

FIG. 3 illustrates placing an object in the system 100 using the radius-delta, placement algorithm, according to an embodiment of the invention. Instead of randomly placing an object anywhere in the system 100, the object (e.g., a child object) is randomly placed within a logical space relative to the parent node. A logical space is the space that includes one or more nodes within a predetermined distance, in terms of logical hops, to another node, such as a parent node. The size of the logical space may be determined by a constant R. The constant R may vary depending on the type of P2P system that is implemented. However, R is generally defined such that the number of logical hops between a parent object and a child object are limited.

FIG. 3 illustrates the system 100 implemented as a two-dimensional, CAN, coordinate system having a virtual space of [0,1]×[0,1]. The node 110a, for example, contains the parent object (i.e., directory “/a”). The node 110a has a zone between 0.5 to 0.75 for the x-axis and 0.5 to 1 for the y-axis. If R is, for example, 0.25, then a child object (e.g., “/a/b/d”) is placed randomly anywhere between 0.25 to 1 for the x-axis and 0.25 to 1 for the y-axis. Thus, R defines an area for the logical space, which has an x-axis from 0.25 to 1 and a y-axis from 0.25 to 1 in the Cartesian coordinate system. The subdirectory “/a/b/d” is shown as being created at node 110b having a zone of [0.25-0.5]×[0.25-0.5]. The dashed line illustrates routing a query to the node 110b for performing a lookup. Lookup costs are minimized by controlling the placement of the child object in the logical space defined by the constant R.

In one embodiment, R is based on a range of consecutive keys. Typically, consecutive keys identify objects hosted by nodes within a limited number of logical hops from each other. Therefore, a child object may be randomly placed at a node hosting objects identified by keys near a key for a parent object. The consecutive keys may identify nodes in a variety of P2P implementations, including but not limited to CAN.

For example, R may include keys of plus or minus three from a key identifying the parent object. Thus, if the parent node 110a hosts a parent object having a key of 7, the child object may be randomly placed at a node hosting objects identified by key between 4 and 10. If node 110b hosts objects identified by any of keys 4-10, then the child object may be placed at node 110b.

The logical space, as defined by R in a CAN system, may include neighbor nodes to the parent node. In another embodiment, the logical space may be limited to the zone controlled by the parent node and the neighbor zones.

The values used for R are provided by way of example and not limitation. Other values of R may be used to optimize a system accordingly. Also, the client 150 shown in FIG. 1, which may be a node in the P2P system 100, may place the object within the logical space.

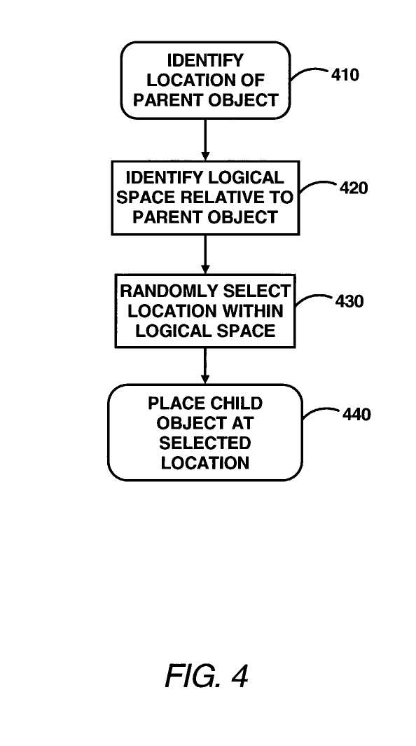

FIG. 4 is a flow diagram of a method 400, according to an embodiment of the invention, for placing an object in the system 100. In step 410, a client identifies the location of a parent object. For example, the client (e.g., the client 150 in the system 100 shown in FIG. 1) determines a location of the parent object, which may include identifying the key associated with the parent object.

In step 420, the client identifies a logical space relative to the location of the parent object for placing the child object. The logical space may be defined by a constant R. For example, R may be a range of keys or coordinates in a CAN system associated with nodes in the logical space.

In step 430, the client randomly selects a location within the logical space for placing the child object. In step 440, the client places the child object in the selected node.

The method 400 may use a range of keys or an area in a CAN system for defining the logical space. It will be apparent to one of ordinary skill in the art that other techniques may be used for determining the logical space. For example, for a CAN system, the logical space may be limited to neighboring zones (i.e. zones neighboring the zone controlled by the node hosting the parent object).

The method 400 is not limited to determining a logical space for placing an object in a P2P, shared, file system. The method 400 and techniques described above may be applied to any application that exists in a tree form to minimize latency (e.g., Btrees and Tries used for indexing in database systems).

The steps of the method 400 may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be operable to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

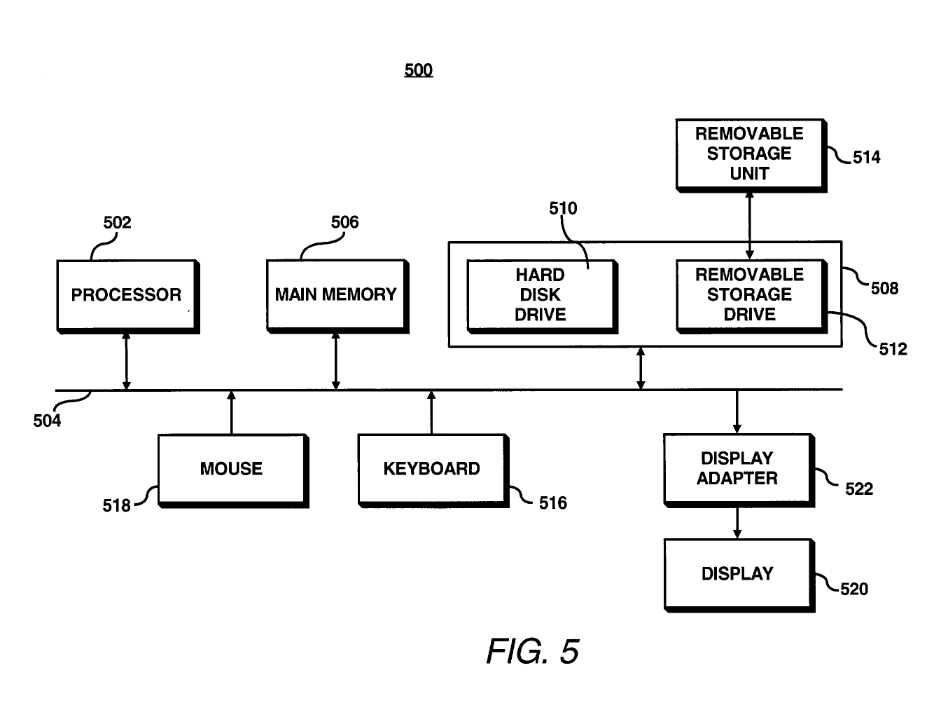

FIG. 5 illustrates an exemplary computer platform 500, according to an embodiment of the invention, for any of the nodes 110a . . . n or the client 150. The platform includes one or more processors, such as the processor 502, that provide an execution platform for software. The software, for example, may execute the steps of the method 400, perform standard P2P functions, etc. Commands and data from the processor 502 are communicated over a communication bus 504. The platform 500 also includes a main memory 506, such as a Random Access Memory (RAM), where the software may be executed during runtime, and a secondary memory 508. The secondary memory 508 includes, for example, a hard disk drive 510 and/or a removable storage drive 512, representing a floppy diskette drive, a magnetic tape drive, a compact disk drive, etc., where a copy of a computer program embodiment for the peer privacy module may be stored. The removable storage drive 512 reads from and/or writes to a removable storage unit 514 in a well-known manner. A user interfaces may interface with the platform 500 with a keyboard 516, a mouse 518, and a display 520. The display adaptor 522 interfaces with the communication bus 504 and the display 520 and receives display data from the processor 502 and converts the display data into display commands for the display 520.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method for placing an object in a peer-to-peer system comprising steps of:
identifying location of a parent object;
identifying a logical space relative to the location of the parent object;
selecting a node within the logical space; and
placing the object at the selected node.

2. The method of claim 1, wherein the step of selecting a node further comprises a step of randomly selecting a node within the logical space.

3. The method of claim 1, wherein the step of selecting a node further comprises steps of:
determining a range of keys associated with the location of the parent object;
randomly selecting a key within the range of keys; and
identifying a node associated with the selected key.

4. The method of claim 3, wherein the step of placing the object further comprises placing the object at the identified node.

5. The method of claim 3, wherein the step of identifying a location of a parent object further comprises identifying a respective key associated with the parent object.

6. The method of claim 5, wherein the step of determining the range of keys further comprises steps of:
identifying a predetermined value to add and subtract from the key associated with the parent object;
adding the predetermined value to the key associated with the parent object for generating an upper endpoint for the range of keys; and
subtracting the predetermined value from the parent key for generating a lower endpoint for the range of keys.

7. The method of claim 1, wherein the logical space comprises a space encompassing a plurality of nodes within a predetermined number of logical hops from the parent node, the selected node being one of the plurality of nodes.

8. The method of claim 1, wherein the peer-to-peer system is a content addressable network having a Cartesian coordinate space.

9. The method of claim 8, wherein the logical space comprises a space including neighbor nodes to a parent node in the Cartesian coordinate space, the parent node being a node hosting the parent object.

10. The method of claim 1, wherein the peer-to-peer system comprises a distributed file system overlaid on the peer-to-peer system, and the parent object includes name and location information for a child object of the parent object in the distributed file system.

11. The method of claim 10, wherein the step of placing the object at the selected node further comprises placing the child object of the parent object at the selected node.

12. A peer-to-peer system comprising a plurality of nodes functioning as a distributed, shared, file system, wherein a node of the plurality of nodes is operable to randomly place a child object within a logical space relative to a parent node hosting a parent object of the child object.

13. The peer-to-peer system of claim 12, wherein the logical space is based upon a range of keys including a parent key, the parent key being a key identifying a location of the parent object.

14. The peer-to-peer system of claim 13, wherein the range of keys is based upon a predetermined value added to and subtracted from the parent key for determining endpoints of the range of keys.

15. The peer-to-peer system of claim 14, wherein the logical space comprises a space encompassing at least some of the plurality of nodes within a limited number of logical hops from the parent node, and the child object is randomly placed at a node in the logical space.

16. The peer-to-peer system of claim 12, wherein the peer-to-peer system is a content addressable network having a Cartesian coordinate space.

17. The peer-to-peer system of claim 15, wherein the logical space includes neighbor nodes to the parent node in the Cartesian coordinate space.

18. The peer-to-peer system of claim 12, wherein the parent object includes name and location information for a child object of the parent object in the distributed file system.

19. The peer-to-peer system of claim 12, wherein the object being placed is the child object of the parent object.

20. An apparatus connected to a peer-to-peer system comprising:
means for identifying a location of a parent object;
means for identifying a logical space relative to the location of the parent object;
means for selecting a node within the logical space; and
means for placing the object at the selected node.

21. The apparatus of claim 20, wherein the means for selecting a node is further operable to randomly select a node within the logical space to the parent node.

22. The apparatus of claim 20, wherein the means for selecting a node is further operable to determine a range of keys associated with nodes within the logical space; randomly select a key within the range of keys; and identify a node associated with the selected key.

23. The apparatus of claim 22, wherein the means for placing the object further comprises placing the object at the identified node.

24. The apparatus of claim 20, wherein the peer-to-peer system is a content addressable network having a Cartesian coordinate space.

25. The apparatus of claim 24, wherein the logical space has a predetermined area within the Cartesian coordinate space.

26. The apparatus of claim 24, wherein the logical space includes neighbor nodes to the parent node in the Cartesian coordinate space.

27. The apparatus of claim 20, wherein the logical space comprises a space encompassing a plurality of nodes within a predetermined number of logical hops from the parent node, the selected node being one of the plurality of nodes.

28. The apparatus of claim 20, wherein the peer-to-peer system comprises a distributed file system overlaid on the peer-to-peer system, and the parent object includes name and location information for a child object of the parent object in the distributed file system.

29. The apparatus of claim 28, wherein the object being placed is the child object of the parent object.
